(19) United States
(12) Patent Application Publication
(10) Pub. No.: US 2004/0220369 A1
(43) Pub. Date: Nov. 4, 2004

(54) Methods for preparing and applying polyurea elastomers and coatings

(76) Inventor: Harry (Zhong-Xiao) Chen, Gilbert, AZ (US)

Correspondence Address: Stephen T. Sullivan, SULLIVAN LAW GROUP, Suite 1140, 1850 North Central Avenue, Phoenix, AZ, 85004-4586, US

(21) Appl. No.: 10/429,265

(22) Filed: May 2, 2003

(51) Int. Cl. C08G 18/00

(52) U.S. Cl. 528/44

(57) ABSTRACT

A method for preparing a polyurea is provided. According to an embodiment of the process, a non-aromatic polyfunctional amine having a plurality of primary amino groups is provided. At least one of the primary amino groups is reacted with a non-aromatic reaction rate modifier to provide a secondary amino group having a hydroxyl-containing moiety and the second reactive hydrogen atom appended to the amino nitrogen. The non-aromatic polyfunctional amine having the secondary amino moiety is combined with an aliphatic polyisocyanate into a sprayable composition. Isocyanate groups of the polyisocyanate are reacted with the primary and secondary amino groups to prepare the polyurea. Preferred examples of the reaction rate modifier include alkylene oxides and alkylene carbonates.

### BACKGROUND OF THE INVENTION

1. Field of the Invention

The present invention relates to methods for making compounds and polymers from secondary amines, and to methods for applying the same to form polyureas and, more preferably, light-stable aliphatic polyurea elastomers and coatings.

2. Description of the Related Art

It is well known that polyurea systems can provide outstanding physical properties, especially when compared to polyurethane systems. Among the notable physical properties possessed by polyurea systems are high tensile strength, high elongation, good low temperature properties, superior flexibility, strong adhesion, and moisture resistance.

However, there are several drawbacks associated with conventional polyurea production processes. Polyureas are generally prepared by reacting a polyisocyanate component with a component having a plurality of active hydrogen atoms, usually a polyfunctional amine. In cases in which aromatic polyisocyanates and/or aromatic polyfunctional amines are used, the aromatic bonds may lead to discoloration and/or UV instability of the resulting polyurea.

For this reason, combinations of aliphatic polyisocyanates and aliphatic diamines or amine-terminated polyether polymers are generally preferred for achieving aliphatic polyurea elastomers and coatings having improved coloration and ultraviolet (UV)-stability. However, low molecular weight aliphatic polyfunctional amines and amine-terminated polymers usually possess primary amino end groups. Primary amino end groups of polyfunctional amines and amine-terminated polymers have been found to react rapidly with aliphatic polyisocyanate components.

The very high reactivities associated with primary amino end groups of aliphatic polyfunctional amines and aliphatic diisocyanates present problems in sprayability. When sprayed, polyureas undergo a critical period, which commences when the reactive components combine, and continues generally until gelation occurs via polymerization. It is generally considered to be important to spray or otherwise apply the polyurea composition during this critical period, before substantial gelation occurs. In the event that the rapid reaction between the primary amino end groups and the aliphatic isocyanate groups speeds polymerization or gelation of the reaction to such a degree that the elastomer-forming composition gels prior to its deposition, the results may be quite deleterious. For example, premature gelling may make the composition virtually unsprayable, causing the spray gun to clog or operate less than optimally. Further, premature gelling of the composition may adversely affect the homogeneity of the deposited polyurea elastomer, resulting in elastomers having less than ideal physical properties, such as tensile strength. Special and expensive high-speed equipment is sometimes employed to mix and spray the elastomer-forming composition prior to gelation. However, such equipment is expensive to purchase and maintain, and may complicate the production process.

Because the reaction between the polyfunctional amine and polyisocyanate components takes place so rapidly, even in the absence of a catalyst, it is highly desirable to provide methods that will permit spraying and application of the components prior to significant gelation. It is further highly desirable to provide a method that permits uniform mixing of the components at a rate as fast as or faster than the rate at which the reaction is taking place to promote uniform mixing and uniform reaction throughout the mixture.

To decrease the reactivity of the polyurea-forming composition, it has been proposed to employ secondary amines as the polyfunctional amine component of the composition. One such secondary amine that has been proposed, for example in U.S. Pat. No. 5,243,012, is a polyaspartic ester derived from a primary polyfunctional amine and dialkyl maleate. The '012 patent states that this secondary amine improves pot lives of aliphatic polyurea coatings. U.S. Pat. Nos. 6,013,755 and 6,399,736 disclose the application of the secondary amine-containing aspartic esters in spray aliphatic polyurea systems; however, the reactivity profile and physical properties may not be considered satisfactory. U.S. Pat. No. 5,312,886 discloses the preparation of secondary amine chain extenders by reductively alkylating di-(4-aminocyclohexyl)methane with methyl ethyl ketone (MEK) over a platinum/alumina catalyst in an autoclave pressurized to 1,000 to 1,500 pounds per square inch (psi) for 5 to 8 hours. The catalysts and high-pressure reaction conditions may increase the manufacturing costs, material costs, and complexity of the polyurea-production process.

There is therefore a need in the art for a process for making high quality, low cost aliphatic light stable polyurea elastomers and coatings without requiring complex catalysts and expensive operating conditions.

### OBJECTS OF THE INVENTION

Accordingly, an object of the present invention is to provide a method for making a polyurea, especially light-stable polyurea elastomers and coatings, the method allowing for controlled or relatively predictable tailoring of the gelation rate and favorable flowability of the system for spraying and other application techniques.

It is another object of the present invention to provide a method for making a polyurea, for example, light-stable polyurea elastomers and coatings, which method may be carried out without complexity under relatively benign operating conditions at relatively low cost.

It is yet another object of the present invention to provide a method for making secondary aliphatic amine-containing compounds and polymers suitable for producing polyurea, for example, light-stable polyurea elastomers and coatings, with favorable physical properties.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, a method for preparing a polyurea is provided in accordance with a first aspect of the invention. The method of this first aspect comprises providing a non-aromatic polyfunctional amine comprising a plurality of primary amino groups, each of the primary amino moieties comprising an amino nitrogen atom and first and second reactive hydrogen atoms appended to the amino nitrogen atom. At least one of the primary amino groups of the non-aromatic polyfunctional amine is reacted with an effective molar amount of a non-aromatic reaction rate modifier to provide a secondary amino group. The reacting comprises replacing the first reactive hydrogen atom with a hydroxyl-containing moiety while leaving the second reactive hydrogen atom appended to the amino nitrogen atom. The non-aromatic polyfunctional amine having the secondary amino group and an aliphatic polyisocyanate comprising a plurality of isocyanate groups are combined into a sprayable composition. The isocyanate groups react with a member selected from the primary and the secondary amino groups to prepare the polyurea.

In accordance with a second aspect of the invention, a method for preparing a polyurea is provided. The method of this second embodiment comprises providing a non-aromatic polyfunctional amine comprising a plurality of primary amino groups, each of the primary amino groups comprising an amino nitrogen atom and first and second reactive hydrogen atoms appended to the amino nitrogen atom. At least one of the primary amino groups of the non-aromatic polyfunctional amine is reacted with an effective molar amount of a non-aromatic reaction rate modifier to provide a secondary amino group. The reacting comprises replacing the first reactive hydrogen atom with a hydroxyl-containing moiety while leaving the second reactive hydrogen atom appended to the amino nitrogen atom. The non-aromatic secondary polyfunctional amine and an aliphatic polyisocyanate comprising a plurality of isocyanate groups are directed onto a substrate and into mutual contact with one another to effectuate mixing and reacting of the isocyanate groups with a member selected from the group consisting of the primary and secondary amino groups.

According to a preferred yet optional embodiment of the first and second aspects of the invention, the non-aromatic polyfunctional amine comprises a diamine. Preferred straight chain and branched diamines include, for example, ethylene diamine, 1,2-propylenediamine, 1,3-dipropylenediamine, tetramethylene diamine, pentamethylene diamine, and hexamethylene diamine (e.g., 1,4-diaminohexane, 1,6-diaminohexane), 1,12-dodecane diamine, dimethylethylene diamine, dimethylpropylene diamine, and/or diethylpropylene diamine. The diamine may also be a cycloaliphatic diamine, such as isophorone diamine, dicyclohexylmethane diamine, cyclohexane diamine, and/or 1,3-cyclohexane-bis(methylene)-diamine. Higher functionality amines, including triamines (e.g., diethylene triamine and dipropylene triamine), tetra-amines, etc., may also be used. The process is preferably conducted free of aromatic polyfunctional amines.

In a preferred embodiment of the first and second aspects of the invention, the polyfunctional amine comprises an amine-terminated polyether, for example, amine-terminated polyethers having average molecular weights of approximately 200 to approximately 7,000.

Reaction rate modifiers according to a preferred embodiment of the first and second aspects of the invention are capable of converting at least some of the primary amine groups into secondary amine groups by reacting with the first reactive hydrogen atoms of the primary amino groups and replacing the first reactive hydrogen atoms with, for example, moieties comprising hydroxyl groups. The reaction rate modifiers are also preferably free of aromatic moieties. According to one preferred embodiment of the invention, the reaction rate modifier comprises an alkylene oxide. The alkylene oxide preferably has from 2 to 6 carbon atoms, and is preferably selected from the group consisting of ethylene oxide, propylene oxide, and butylene oxide. The reaction rate modifier according to another preferred embodiment of the invention comprises an alkylene carbonate. Preferred alkylene carbonates include ethylene carbonate and propylene carbonate.

By varying the molar ratio of reaction rate modifier to primary amino groups, the cure rate of the polyurea system may be controlled in the first and second aspects of the invention. For example, relatively low molar ratios of reaction rate modifier to primary amino groups will leave a relatively high percentage of unconverted primary amino groups and a relatively low percentage of secondary amino groups. Hence, greater molar ratios of primary amino groups will be available for reacting with the polyisocyanates, thereby resulting in faster polyurea reactions. By the same token, increasing the amount of reaction rate modifier can cause a reduction in the number of primary amino groups and an increase in the molar percentage of secondary amino groups. Hence, lower molar ratios of primary amino groups will be available for reaction with the polyisocyanates, thereby resulting in slower polyurea reactions. In a presently preferred embodiment, the molar ratio of reaction rate modifier to primary amino groups is in a range of about 1:3 to about 1:1, even more preferably about 1:2 to about 2:3.

The aliphatic polyisocyanate of a preferred embodiment of the first and second aspects of the invention comprises a non-aromatic polyisocyanate, and more preferably a non-aromatic diisocyanate. The non-aromatic diisocyanate preferably comprises an alkylene moiety connecting the isocyanate groups, wherein the alkylene moiety is selected from the group consisting of a straight-chain and branched alkylene moiety. In another preferred embodiment, the linking alkylene moiety has up to 12 carbon atoms. Preferred non-aromatic diisocyanate include ethylene diisocyanate, propylene diisocyanate, 1,4-tetramethylene diisocyanate, 1,6- and 1,4-hexamethylene diisocyanate, 1,12-dodecane diisocyanate and trimethylhexamethylene diisocyanate, and mixtures thereof. Other preferred non-aromatic diisocyanates comprise a cyclic alkylene linking moiety connecting the isocyanate groups, the cyclic alkylene moiety having 4 to 14 carbon atoms. Examples of linking cyclic alkylene moieties include 1,3-cyclohexylene diisocyanate, 1,4-cyclohexylene diisocyanate, 4,4′-dicyclohexylmethane diisocyanate, and isophorone diisocyanate, and mixtures thereof. Triisocyanates and higher functional isocyanates may also be selected, alone or in combination with diisocyanates. The process is preferably conducted free of aromatic isocyanates, although it is within the scope of this invention to use so-called aliphatic polyisocyanates having at least one aromatic ring in which the isocyanate group is a tertiary aliphatic diisocyanate group. In such compounds, the carbon atom appended to the isocyanate group (and interposed between the isocyanate group and the aromatic ring) lacks an active hydrogen. One example of such a light-stable aliphatic polyisocyanate comprising an aromatic ring is tetramethylxylenediisocyanate (TMXDI), i.e., OCN—C(CH₃)₂C₆H₄C(CH₃)₂—NCO. The light-stable polyisocyanate selected for the inventive process preferably has an average isocyanate functionality of 1.8 to 4.0, more preferably 2 to 3, and still more preferably 2 to 2.3.

According to another preferred embodiment of the first and second aspects of the invention, the non-aromatic polyfunctional amine having the secondary amino group comprises a first non-aromatic polyfunctional amine, and the process further comprises blending the first non-aromatic polyfunctional amine with a second non-aromatic polyfunctional amine comprising a plurality of second primary amino groups. Preferably, the second non-aromatic polyfunctional amine comprises polyoxyalkyleneamine.

In accordance with certain preferred embodiments of this invention, the produced polyurea advantageously possesses acceptable gel and tack free times. As a result, the polyurea may be applied, such as by spraying, onto a substrate to produce a smooth surface. In addition, by varying the degree to which primary amino groups are converted to secondary amino groups, and the content of the aliphatic secondary amine-containing compounds, a variety of system reactivities can be achieved. The process may be tailored to provide relatively slow cure aliphatic polyurea elastomers and coatings that exhibit excellent physical properties such as tensile strength, elongation, and adhesion.

### DETAILED DESCRIPTION OF THE PREFERRED EMBODIMENTS AND METHODS

Reference will now be made in detail to the presently preferred embodiments and methods of the invention. It should be noted, however, that the invention in its broader aspects is not limited to the specific details, representative compositions and methods, and illustrative examples shown and described in this section in connection with the preferred embodiments and methods. The invention according to its various aspects is particularly pointed out and distinctly claimed in the attached claims read in view of this specification, and appropriate equivalents.

It is to be noted that, as used in the specification and the appended claims, the singular forms “a,” “an,” and “the” include plural referents unless the context clearly dictates otherwise.

A “polyurea” is understood to mean a polymer containing urea groups and/or optionally urethane groups. The polyurea elastomers and coatings of the present invention are preferably characterized by urea linkages formed by the reaction of active amino groups of polyfunctional amines with isocyanate groups of polyisocyanates. However, hydroxyl groups or other groups containing an active hydrogen atom may optionally also be present as active-hydrogen groups in the reaction mixture.

In accordance with aspects of the invention, methods are provided for preparing a light-stable polyurea and applying the light-stable polyurea to a substrate.

According to these aspects of the invention, a non-aromatic polyfunctional amine comprising a plurality of primary amino groups is provided. As referred to herein, the term “polyfunctional amine” includes compounds having two or more amino groups. The polyfunctional amine may optionally have other non-amino functional groups, but this is not required or necessarily preferred. The non-aromatic polyfunctional amine may have, for example, a combination of primary and secondary amino groups. A primary amino group is generally understood in the art as having the structure RNH₂, comprising an amino nitrogen atom, first and second reactive hydrogen atoms appended to the amino nitrogen atom, and R, which may be, for example and not necessarily limitation, and alkyl or ether group. The designation of the reactive hydrogen atoms as “first” and “second” is arbitrary. A secondary amino group is generally understood in the art as having the structure RR₁NH, in which R and R₁ may be the same or different and may comprise, for example and not necessarily by limitation, an alkyl or ether moiety. R and R₁ preferably are not aromatic.

In accordance with a preferred embodiment of the invention, the non-aromatic polyfunctional amine comprises a diamine having two primary amino groups. Examples of diamines suitable for the present invention include straight chain and branched diamines, including, but not necessarily limited to, ethylene diamine, 1,2-propylenediamine, 1,3-dipropylenediamine, tetramethylene diamine, pentamethylene diamine, and hexamethylene diamine (e.g., 1,4-diaminohexane, 1,6-diaminohexane), 1,12-dodecane diamine, dimethylethylene diamine, dimethylpropylene diamine, and diethylpropylene diamine, and combinations thereof. Cycloaliphatic diamines may be used exclusively or in combination with straight and/or branched diamines. Examples of cycloaliphatic diamines include, but are not necessarily limited to, isophorone diamine, dicyclohexylmethane diamine, 1,3-cyclohexane bis(methylamine), and cyclohexane diamine, and combinations thereof.

In accordance with a preferred embodiment of the invention, the non-aromatic polyfunctional amine comprises a triamine having either three primary amino groups or a combination of two primary amino groups and one secondary amino group. Examples of triamines suitable for the present invention comprise diethylene triamine and/or dipropylene triamine. The non-aromatic polyfunctional amine preferably has a functionality (amino groups per molecule) of between approximately 2.0 and approximately 3.0, and more preferably approximately 2.0 and approximately 2.3. The process is preferably conducted essentially free of aromatic polyfunctional amines.

In accordance with another preferred embodiment of the present invention, the polyfunctional amine comprises a polyamine, such as an amine-terminated polyether or polyoxyalkyleneamines. The production of amine-terminated polyethers is generally known in the art, and may proceed, for example, by reacting a lower alkylene oxide with an initiator (e.g., a polyol) to form a hydroxyl-terminated polyether. The functionality of the initiator will generally govern the functionality of the polyether. The hydroxyl-terminated polyether may optionally be capped with a small amount of a higher alkylene oxide so that the terminal hydroxyl groups are secondary hydroxyl groups. The polyether is then aminated. Examples of difunctional and trifunctional amine-terminated polyethers that may be used in accordance with the principals of the present invention include Jeffamine® series of polyether amines available from Texaco Chemical Company, including Jeffamine® D-230, D-400, D-2000, D-4000, ED-600, ED-900, ED-2001 T-403, T-3000, T-4000 and T-5000.

According to preferred aspects of the present invention, at least one of the primary amino groups is converted into a secondary amino group. This conversion preferably proceeds by a method comprising reacting at least one of the primary amino groups of the non-aromatic polyfunctional amine with an effective molar amount of a non-aromatic reaction rate modifier to provide a secondary amino group, said reacting comprising replacing the first reactive hydrogen atom with a hydroxyl-containing moiety while leaving the second reactive hydrogen atom appended to the amino nitrogen atom.

It is possible to tailor and/or adjust/influence the cure rate of the polyurea system by controlling the effective molar amount of the non-aromatic reaction rate modifier. The molar ratio of reaction rate modifier to primary amino groups affects the ratio of secondary amino groups to primary amino groups remaining after this reaction takes place. All, substantially all, or a portion of the primary amino groups may be converted into secondary amino groups. Where slower cure rates are desired, a relatively high ratio of reaction rate modifier to primary amino groups may be used to convert a high ratio or all of the primary amino groups into secondary amino groups. The secondary amino groups will react more slowly with isocyanates than the primary amino groups during curing with the isocyanate, thereby slowing the overall cure rate. On the other hand, where faster cure rates are desired, a relatively low ratio of reaction rate modifier to primary amino groups may be used to convert a relatively low ratio of the primary amino groups into secondary amino groups. The relatively high number of residual primary amino groups will drive the cure rate faster because, as described above, primary amino groups are more reactive with isocyanates than secondary amino groups. In a presently preferred embodiment, the molar ratio of reaction rate modifier to primary amino groups is in a range of about 1:3 to about 1:1, even more preferably about 1:2 to about 2:3.

The reaction rate modifiers according to a preferred embodiment of the invention are capable of replacing the first reactive hydrogen atoms of the primary amino groups so that the reaction product comprises a secondary amino group having a moiety comprising a primary or secondary hydroxyl group. Without wishing to necessarily be bound by any particular theory, it is believed that the primary or secondary hydroxyl groups will be less reactive with isocyanate groups than the primary and secondary amino groups. As a consequence, and again without wishing to be bound by any particular theory, it is believed that the secondary hydroxyl groups will have little or no influence on the reaction rate between the polyfunctional amine and polyisocyanate.

According to a preferred embodiment of the invention, the reaction rate modifier comprises an oxirane having the following formula:

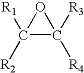

and more preferably

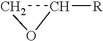

wherein R and R₁ to R₄ are identical or different and denote a member selected from the group consisting of hydrogen, a straight chain alkyl, a branched alkyl, and a cyclic alkyl radical, wherein R₁ and R₂, R₃ and R₄, R₁ and R₂, and/or R₂ and R₄ may be linked by an alkyl radical to form a ring of 5 to 6 carbon atoms. Straight-chain or branched alkyl radicals which may be selected include hydrocarbon radicals with 1 to 18, preferably 1 to 12 carbon atoms, such as methyl, ethyl, propyl, isopropyl, butyl, isobutyl, pentyl, isopentyl, and isohexyl. Most preferably, the oxirane reaction rate modifier comprises an alkylene oxide, preferably having 2 to 6 carbon atoms. Ethylene oxide, propylene oxide, and 1,2-epoxy butane, are currently preferred. The oxirane reaction rate modifier may also possess one or more halogen atoms, such as chlorine atoms. An example includes epichlorohydrin.

Generally, alkylene oxide reacts with a non-aromatic amine containing two primary amino groups via hydroxyalkylation. Shown below are examples of reactions of a difunctional primary amine with ethylene oxide and propylene oxide, respectively:

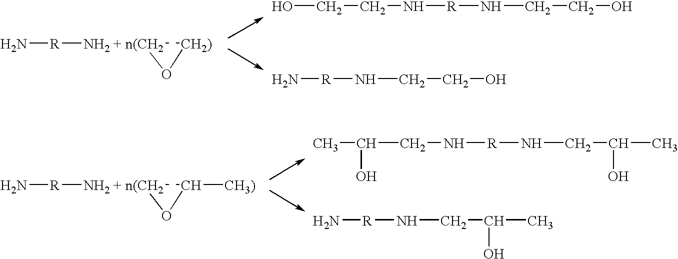

When ethylene oxide used, the resulting compounds or polymers contain at least one secondary amine, optionally a primary amine (depending upon the ratios of reaction rate modifier to amino groups), and primary hydroxyl groups. If propylene oxide used, the resulting compounds or polymers contain at least one secondary amine, optionally a primary amine (depending upon the ratios of reaction rate modifier to amino groups), and secondary hydroxyl groups.

Another preferred group of reaction-rate modifiers comprise alkylene carbonates, such as ethylene carbonate and propylene carbonate. Generally, alkylene carbonate reacts with a non-aromatic amine containing two primary amino groups as follows:

H₂NRNH₂+(—R₁CH₂—O)₂CO→H₂NRNHC(O)OCH₂R₁OH,

and/or

H₂NRNH₂+(—R₁CH₂—O)₂CO→R(NHC(O)OCH₂R₁OH)₂

wherein R₁ is optional and may comprise an alkylene moiety, and R is preferably a straight, branched or cyclic alkylene linking group or ether linking group.

Other reaction rate modifiers that may be used in accordance with other embodiments of this invention include, for example, acrylonitrile, aldehydes, and ketones.

The non-aromatic polyfunctional amine having at least one secondary amino group (and optionally at least one primary amino group) is combined with an aliphatic polyisocyanate comprising a plurality of isocyanate groups to form a sprayable composition. The second reactive hydrogen atoms of the secondary amino groups, together with first and second hydrogen atoms of any primary amino groups in the polyfunctional amine, react with the isocyanate groups of the polyisocyanate to form urea linkages.

As referred to herein, aliphatic polyisocyanates are compounds that include a plurality of isocyanate groups, but not do have an aromatic ring, except as otherwise defined herein, e.g., see TMXDI. According to a preferred embodiment of the invention, the light-stable polyisocyanate comprises a non-aromatic polyisocyanate. Exemplary non-aromatic diisocyanates suitable for the present invention include, for example, those having an alkylene moiety connecting the isocyanate groups, wherein the alkylene moiety is preferably selected from the group consisting of straight-chain and branched alkylene moieties. The alkylene linking-moieties preferably have from 1 to 12 carbon atoms. Examples include, but are not necessarily limited to, ethylene diisocyanate, propylene diisocyanate, 1,4-tetramethylene diisocyanate, 1,6- and 1,4-hexamethylene diisocyanate, 1,12-dodecane diisocyanate, and trimethylhexamethylene diisocyanate, and combinations thereof. Cyclic light-stable polyisocyanates that may be used within the scope of aspects of this invention include, for example, those having 4 to 14 carbon atoms, such as 1,3-cyclohexylene diisocyanate, 1,4-cyclohexylene diisocyanate, 4,4′-dicyclohexylmethane diisocyanate, and isophorone diisocyanate, and combinations thereof. The light-stable polyisocyanate may comprise a non-aromatic triisocyanate or higher functionality polyisocyanate. Different functionality polyisocyanates may be used in combination with one another. Preferably, the light-stable polyisocyanate(s) used in the invention have an average isocyanate functionality of about 1.8 to about 4, preferably about 2 to about 3, and more preferably about 2 to about 2.3.

Preferably, the process is conducted in the absence of aromatic polyisocyanates. However, it is within the scope of this invention to use so-called aliphatic polyisocyanates having at least one aromatic ring. Such aliphatic polyisocyanates comprise at least one tertiary aliphatic diisocyanate group. In such compounds, the tertiary carbon atom appended to the isocyanate group (and interposed between the isocyanate group and the aromatic ring) lacks an active hydrogen. One example of such a light-stable aliphatic polyisocyanate is tetramethylxylenediisocyanate (TMXDI), i.e., OCN—C(CH₃)₂C₆H₄C(CH₃)₂—NCO.

In accordance with another preferred embodiment of the present invention, the method further comprises blending the non-aromatic polyfunctional amine having the secondary amino group with additional polyfunctional amine(s), especially one or more polyoxyalkyleneamines, that is, amine-terminated polyethers, and low molecular weight aliphatic amines as crosslinkers, including secondary amine-containing compounds prepared based on the present invention. Examples of amine-functional polyethers or polyoxyalkyleneamines that are known and commercially available include Jeffamine® D-230, Jeffamine® D-400, Jeffamine® D-2000, Jeffamine® D-4000, Jeffamine® ED-600, Jeffamine® ED-900, Jeffamine® ED-2001, Jeffamine® D-403, Jeffamine® T-3000, and Jeffamine® T-5000. High functionality and low molecular weight amine -functional polyethers create a polyurea elastomer having a network comprising a relatively high density of crosslinkage and relatively low average molecular weight moieties between the crosslinked points, thereby imparting high tensile strength and low elongation to polyurea elastomer. On the other hand, low functionality and high molecular weight amine-functional polyethers create a polyurea elastomer having a network comprising a relatively low number of crosslinks and relatively high average molecular weight moieties between the crosslinks, thereby imparting high elongation and elasticity to polyurea elastomer.

An advantage of some/many embodiments of the present invention is that the polyurea may be prepared without requiring solvent or water, although their use is not necessarily precluded. As a result, the overall process can be simplified, and the risks of solvent contamination are eliminated. Another advantage of embodiments of the invention is that the process of these embodiments does not require the use of catalysts, although their use is not necessarily precluded from the scope of the invention.

Various fillers may be used in accordance with certain embodiments of the invention. Selection of the desired fillers will depend upon many factors, including the desired end use of the polyurea product and any special manufacturing needs. For example, pigments and colorants, such as titanium dioxide, may be used. Other suitable fillers and additives, pigments are known in the polyurea and polyurethane arts.

In a preferred application process, the polyfunctional amine blend and polyisocyanate curative are combined or mixed under high pressure in high pressure equipment, such as a spray gun. Polyurea and polyurethane spray guns and pour guns and equipment are well known and widely used in the industry. Preferably, pressurized streams of the polyfunctional amine blend component and the polyisocyanate curative component, respectively, are delivered from separate chambers and are impacted or impinged upon each other at high velocities to effectuate an intimate mixing of the two components. The intermixed components are then sprayed, coated, brushed, or otherwise applied to the desired substrate, for example, via the spray gun. It should be understood that the invention is not limited to high-pressure application equipment. Rather, other equipment and techniques, including simple hand mixing, may be employed. The application temperature may vary depending upon the application technique and polyurea composition. Generally, the process of embodiments of the present invention may be carried out at, for example, room temperature to approximately 94° C. (approximately 200° F.) or higher.

Substrates that may be coated by embodiments of the process of the present invention include, not necessarily by limitation, metals, plastics, wood, cement, ceramics, concrete, and/or glass. The substrate may be treated with suitable primers before the process according to embodiments of this invention is carried out. Further, the process of the present invention may be applied multiple times on a single substrate to apply a plurality of layers or coatings to the substrate, with each layer/coating being the same or different from one another.

### EXAMPLES

The following examples serve to further illustrate the principles and advantages of the present invention, but should not necessarily be interpreted as being exhaustive of or exclusive to the scope of the present invention.

### Example 1

Partial Conversion of Primary Amine of 1,3-diaminopentane (Dytek-EP) into Secondary Amine by Ethylene Carbonate

Ethylene carbonate (EC) was reacted with 1,3-diaminopentane (a commonly used curing agent for epoxy resins) by dropping EC into Dytek-EP with stirring at room temperature for one hour. The molar ratio of EC to Dytek-EP was 1.0/1.0. It was expected that 50% of the primary amine groups of Dytek-EP would be converted into secondary amine groups. The resulting compound was a colorless liquid. For the purpose of comparing the reactivities of modified and unmodified amines, a basic aliphatic polyurea system formulation was designed as follows. A resin blend component of Jeffamine® D-2000 (45.61 pbw—parts by weight), Jeffamine® T-5000 (10.01 pbw), Clearlink®-1000 (21.02 pbw), titanium dioxide (11.4 pbw), and 11.96 pbw of modified (Example 1) or un-modified (Comparative Example A) aliphatic amine crosslinker was prepared. The resin blend component was mixed with an aliphatic isocyanate component (a quasi-prepolymer of isophorone diisocyanate (IPDI)) and Jeffamine® D-2000 (D-2000) having the ratio 45/55 of IPDI to D-2000, as set forth in Table 1. This basic formulation was used for preparing the resin blend component and the aliphatic isocyanate component in each of the examples and comparative examples that follow, unless otherwise specifically noted.

TABLE 1

| | | Primary | Secondary | Weight % | Mixing | Gel | Tackfree |
|---|---|---|---|---|---|---|---|
| Ex. | Crosslinker | amine % | amine % | of crosslinker | (seconds) | (seconds) | (seconds) |
| 1 | Modified | 50% | 50% | 11.96 | 4.0 | 7-15 | 58 |
| | Dytek-EP | | | | | | |
| A | Dytek-EP | 100% | 0.0% | 11.96 | 4.0 | 4.2 | 8.5 |

It is clear that a 50% conversion of primary amine into secondary amine group of 1,3-diaminopetane imparts very slow reaction rate to modified aliphatic polyurea system compared to the unmodified 1,3-diaminopentane.

### Example 2

Partial Conversion of Primary Amine Group of 2-methyl-1,5-pentanediamine (Dytek A Amine) into Secondary Amine Group with Ethylene Carbonate

2-methyl-1,5-pentanediamine (Dytek A amine), which is widely used as curing agent or crosslinker in the epoxy resin industries, was reacted with ethylene carbonate (EC) by dropping EC into Dytek A amine with stirring at room temperature for one hour. The mole ratio of EC to Dytek A amine was 1.0/1.0. It was expected that 50% of the primary amine group of Dytek A amine would be converted into secondary amine groups. Table 2 shows the measured properties.

TABLE 2

| | | Primary | Secondary | Weight % | Mixing | Gel | Tackfree |
|---|---|---|---|---|---|---|---|
| Ex. | Crosslinker | amine % | amine % | of crosslinker | (seconds) | (seconds) | (seconds) |
| 2 | Modified | 50% | 50% | 11.96 | 4.0 | 8-21 | 115 |
| | Dytek-A | | | | | | |
| B | Dytek-A | 100% | 0.0% | 11.96 | 4.0 | 4.1 | 15 |

As shown in Table 2, the polyurea of Example 2 showed a slower gel time and a significantly slower tackfree time than exhibited by Comparative Example B.

### Example 3

Conversion of Primary Amine Group of Jeffamine® D-230 into Secondary Amine Group Partially by Ethylene Carbonate

Jeffamine® D-230, an amine-terminated polyether having functionality of two and molecular weight of 230, has been widely used for making aromatic and aliphatic polyurea elastomers and coatings. Ethylene carbonate (EC) was reacted with D-230 by dropping EC into D-230 with stirring at 84.4° C. (184° F.) for two hours. The molar ratio of EC to D-230 was 1.0/1.0. It was expected that 50% of the primary amine groups of D-230 would be converted into secondary amine groups. The resulting modified D-230 was a colorless and viscous liquid.

TABLE 3

| | | Primary | Secondary | Weight % | Mixing | Gel | Tackfree |
|---|---|---|---|---|---|---|---|
| Ex. | Crosslinker | amine % | amine % | of crosslinker | (seconds) | (seconds) | (seconds) |
| 3 | Modified D- | 50% | 50% | 11.96 | 4.0 | 11-25 | 59 |
| | 230 | | | | | | |
| C | D-230 | 100% | 0.0% | 11.96 | 4.0 | 5.0 | 19 |

As shown in Table 3, the polyurea of Example 3 showed slower gel time and a significantly slower tackfree time than those of Comparative Example C.

### Example 4

Partial Conversion of Primary Amine Group of Jeffamine® D-400 into Secondary Amine Group by Ethylene Carbonate

Jeffamine® D-400, an amine-terminated polyether having functionality of two and molecular weight of 400, has been widely used in the production of aromatic and aliphatic polyurea elastomers and coatings. Ethylene carbonate (EC) was reacted with D-400 by dropping EC into D-400 with stirring at 22° C. (72° F) for two hours. The molar ratio of EC to D-400 was 1.0/1.0. It was expected that 50% of the primary amine groups of D-400 would be converted into secondary amine groups. The resulting modified D-400 was a colorless and viscous liquid. The results are shown in Table 4 below:

TABLE 4

| | | Primary | Secondary | Weight % | Mixing | Gel | Tackfree |
|---|---|---|---|---|---|---|---|
| Ex. | Crosslinker | amine % | amine % | of crosslinker | (seconds) | (seconds) | (seconds) |
| 4 | Modified | 50% | 50% | 11.96 | 5.0 | 14-20 | 92 |
| | D-400 | | | | | | |
| D | D-400 | 100% | 0.0% | 11.96 | 5.0 | 7.2 | 75 |

As shown in Table 4, the polyurea of Example 4 showed slower gel and tackfree times than those of Comparative Example D. In fact, the gel time of Example 4 was at least approximately twice as long as that of Comparative Example D.

### Example 5

Partial Conversion of Primary Amine Group of Jeffamine® T-403 into Secondary Amine Group Partially by Ethylene Carbonate

Jeffamine® T-403 is an amine-terminated polyether having functionality of three and molecular weight of 400. Jeffamine® T-403 has been widely used in aromatic and aliphatic polyurea elastomers and coatings. Ethylene carbonate (EC) was reacted with T-403 by dropping EC into T-403 with stirring at 65.6° C. (150° F.) for two hours. The mole ratio of EC to T-403 was 1.0/1.0. It was expected that 50% (1.5 of every 3) of the primary amine groups of T-403 would be converted into secondary amine groups. The resulting modified T-403 was a colorless and viscous liquid.

The results are shown in Table 5 below:

TABLE 5

| | | Primary | Secondary | | Mixing | Gel | Tackfree |
|---|---|---|---|---|---|---|---|
| Ex. | Crosslinker | amine % | amine % | Weight % | (seconds) | (seconds) | (seconds) |
| 5 | Modified T- | 50% | 50% | 11.96 | 5.0 | 40 | 78 |
| | 403 | | | | | | |
| E | T-403 | 100% | 0.0% | 11.96 | 5.0 | 5.0 | 55 |

As shown in Table 5, the polyurea of Example 5 showed slower gel and tackfree times than exhibited by Comparative Example E.

### Example 6

Conversion of Primary Amine Group of Jeffamine® T-403 into Secondary Amine Group Partially by Propylene Oxide

Jeffamine® T-403 is an amine-terminated polyether having functionality of three and molecular weight of 400. Jeffamine® T-403 has been widely used in aromatic and aliphatic polyurea elastomers and coatings. Propylene oxide was reacted with T-403 in a stainless steel high pressure reactor. The molar ratio of propylene oxide to T-403 was 1.5/3.0. It was expected that 50% of the primary amine groups of T-403 would be converted into secondary amine groups (that is, an average of 1.5 of three primary amine groups of T-403 were converted into secondary amine groups). T-403 was added into reactor first, a vacuum was made and nitrogen was purged three times. After heating up to 115.6° C. (240° F.), propylene oxide was added and the pressure was maintained at no higher than 50 psi. After a four-hour reaction, the pressure in the reactor reached almost zero psig. The reactor was vacuumed at 115.6° C. (240° F.) to remove trace amount of un-reacted propylene oxide. The resulting modified T-403 was a colorless and viscous liquid. The results are shown in Table 6 below:

TABLE 6

| | | Primary | Secondary | | Mixing | Gel | Tackfree |
|---|---|---|---|---|---|---|---|
| Ex. | Crosslinker | amine % | amine % | Weight % | (seconds) | (seconds) | (seconds) |
| 6 | Modified T- | 50% | 50% | 11.96 | 5.0 | 15-45 | 69 |
| | 403 | | | | | | |
| F | T-403 | 100% | 0.0% | 11.96 | 5.0 | 5.0 | 55 |

As shown in Table 6, the polyurea of Example 6 showed slower gel and tackfree times than that of Comparative Example F.

### Example 7

Partial Conversion of Primary Amine Group of Diethylene Triamine (DETA) into Secondary Amine Group by Propylene Oxide

Diethylene triamine (DETA) contains two primary amine groups and one secondary amine group. Propylene oxide was reacted with diethylene triamine in a stainless steel high pressure reactor. The molar ratio of propylene oxide to diethylene triamine (DETA) was 1.0/1.0. It was expected that 50% of the primary amine groups of diethylene triamine (DETA) would be converted into secondary amine groups. Diethylene triamine (DETA) was added into reactor first, a vacuum was made and nitrogen purged three times. After heating up to 93.3° C. (200° F.), propylene oxide was added and the pressure was maintained at no greater than 50 psig. After a three-hour reaction, the pressure in the reactor reached almost zero psig. Vacuum at 93.3° C. (200° F.) was applied to remove trace amount of un-reacted propylene oxide. The resulting modified diethylene triamine was a light yellow transparent, viscous liquid. The results are shown in Table 7 below:

TABLE 7

| | | Primary | Secondary | | Mixing | Gel | Tackfree |
|---|---|---|---|---|---|---|---|
| Ex. | Crosslinker | amine % | amine % | Weight % | (seconds) | (seconds) | (seconds) |
| 7 | Modified | 33% | 77% | 11.96 | 5.0 | 6.5 | 35 |
| | DETA | | | | | | |
| G | DETA | 77% | 33% | 11.96 | 5.0 | 5.0 | 15 |

As shown in Table 7, the polyurea of Example 7 showed slower gel and tackfree times than that of Comparative Example G.

The resulting secondary amine-containing compounds and polymers based on embodiments of the method of the present invention were tested in aliphatic spray polyurea elastomer systems. The results are shown in following examples.

### Example 8

Using Jeffamine® T-403 Modified by Propylene Oxide in Aliphatic Spray Polyurea Elastomer System as Slower Crosslinker

The resin component of Example 8 was prepared from the following formulation: Jeffamine® T-5000 (26 pbw), Jeffamine® D-2000 (15 pbw), Jeffamine® T-403 (16 pbw), Isophorone diamine (IPDA) (6.0 pbw), and modified Jeffamine® T-403 (T-403-PO-1.5) (35 pbw). The modified Jeffamine® T-403 had 50% of its primary amine groups converted into secondary amine groups. The aliphatic diisocyanate component of Example 8 comprised a quasi prepolymer of tetramethylxylene diisocyanate (60% by weight) and Jeffamine® D-2000 (40% by weight). MX-II spray unit was used for spray at hose temperature of 71.1° C. (160° F.) and a pressure of 2000 psi. The ratio of diisocyanate component to resin component was 50/50 by weight.

TABLE 8
Physical properties of sprayed aliphatic elastomer

| | T-403-PO- | Temp. | Pressure | Tackfree | σ (tensile | | |
|---|---|---|---|---|---|---|---|
| Ex. | 1.5% | (hose) | (hose) | (seconds) | strength) | ε (elongation) | Surface |
| 8 | 35.0 | 160° F. | 2000 psi | 7.8 | 2066 psi | 138% | Smooth |

### Example 9

The resin component of Example 9 comprised Jeffamine® T-5000 (34 pbw), Jeffamine® D-2000 (10 pbw), Jeffamine® D-230 (10 pbw), modified T-403-PO-1.5:35 (pbw), and isophorone diamine (IPDA) (6.0 pbw). The aliphatic diisocyanate component of Example 9 comprised a quasi prepolymer of tetramethylxylene diisocyanate (50% by weight) and Jeffamine® D-2000 (50% by weight). The same spray unit and same conditions were used as described above in Example 8.

TABLE 9
Physical properties of sprayed aliphatic elastomer

| | T-403-PO- | Temp. | Pressure | Tackfree | σ (tensile | | |
|---|---|---|---|---|---|---|---|
| Ex. | 1.5% | (hose) | (hose) | (seconds) | strength) | ε (elongation) | Surface |
| 9 | 35.0 | 160° F. | 2000 psi | 10.8 | 1828 psi | 255% | Smooth |

The polyureas of Examples 8 and 9 both had a tensile strength of greater than 1800 psi and elongation of greater than 125%.

Additional advantages and modifications will readily occur to those skilled in the art. Therefore, the invention in its broader aspects is not limited to the specific details, representative devices and methods, and illustrative examples shown and described. Accordingly, departures may be made from such details without departing from the spirit or scope of the general inventive concept as defined by the appended claims and their equivalents.

1. A method for preparing a polyurea, the method comprising:
providing a non-aromatic polyfunctional amine comprising a plurality of primary amino groups, each of the primary amino groups comprising an amino nitrogen atom and first and second reactive hydrogen atoms appended to the amino nitrogen atom;
reacting at least one of the primary amino groups of the non-aromatic polyfunctional amine with an effective molar amount of a non-aromatic reaction rate modifier to provide a secondary amino group, said reacting comprising replacing the first reactive hydrogen atom with a hydroxyl-containing moiety while leaving the second reactive hydrogen atom appended to the amino nitrogen atom; and
combining the non-aromatic polyfunctional amine having the secondary amino group and an aliphatic polyisocyanate comprising a plurality of isocyanate groups into a sprayable composition and reacting the isocyanate groups with at least one member selected from the group consisting of the primary and secondary amino groups to prepare the polyurea.

2. A method according to claim 1, wherein the non-aromatic polyfunctional amine comprises a diamine.

3. A method according to claim 2, wherein the diamine comprises a member selected from the group consisting of a straight chain and branched diamine.

4. A method according to claim 2, wherein the diamine comprises a cycloaliphatic diamine.

5. A method according to claim 1, wherein the polyfunctional amine comprises a triamine.

7. A method according to claim 1, wherein the effective molar amount of the non-aromatic reaction-rate modifier to the primary amino groups is in a range of about 1:3 to about 1:1.

8. A method according to claim 1, wherein the effective molar amount of the non-aromatic reaction-rate modifier to the primary amino groups is in a range of about 1:2 to about 2:3.

9. A method according to claim 1, wherein said reacting of the non-aromatic polyfunctional amine with the non-aromatic reaction rate modifier comprises replacing the first reactive hydrogen atom with a moiety comprising a secondary hydroxyl group.

10. A method according to claim 1, wherein said reacting of the non-aromatic polyfunctional amine with the non-aromatic reaction modifier comprises a hydroxyalkylation reaction.

11. A method according to claim 1, further comprising selecting an alkylene oxide as the reaction-rate modifier.

12. A method according to claim 11, wherein the alkylene oxide has 2 to 6 carbon atoms.

13. A method according to claim 11, wherein the alkylene oxide comprises a member selected from the group consisting of ethylene oxide and propylene oxide.

14. A method according to claim 1, further comprising selecting an alkylene carbonate as the reaction-rate modifier.

15. A method according to claim 14, wherein the alkylene carbonate comprises a member selected from the group consisting of ethylene carbonate and propylene carbonate.

16. A method according to claim 1, wherein the aliphatic polyisocyanate comprises a non-aromatic diisocyanate.

17. A method according to claim 16, wherein:
the non-aromatic diisocyanate comprises an alkylene moiety connecting the isocyanate groups; and
the alkylene moiety is selected from the group consisting of a straight-chain alkylene moiety, a branched alkylene moiety, and straight and branched alkylene moieties.

18. A method according to claim 17, wherein the alkylene moiety has 1 to 12 carbon atoms.

19. A method according to claim 16, wherein the non-aromatic diisocyanate comprises a cyclic alkylene moiety connecting the isocyanate groups, the cyclic alkylene moiety having 4 to 14 carbon atoms.

20. A method according to claim 1, wherein the aliphatic polyisocyanate comprises a non-aromatic triisocyanate.

21. A method according to claim 1, wherein said combining step is free of aromatic isocyanates.

22. A method according to claim 1, wherein the aliphatic polyisocyanate comprises an aromatic ring and a tertiary carbon, wherein the tertiary carbon is appended to one of the isocyanate groups.

23. A method according to claim 22, wherein the aliphatic polyisocyanate comprises tetramethylxylenediisocyanate.

24. A method according to claim 1, wherein the non-aromatic polyfunctional amine having the secondary amino group comprises a first non-aromatic polyfunctional amine, and wherein said method further comprises blending the first non-aromatic polyfunctional amine with a second non-aromatic polyfunctional amine comprising a plurality of second primary amino groups.

25. A method according to claim 24, wherein the second non-aromatic polyfunctional amine comprises polyoxyalkyleneamine.

26. A method according to claim 1, wherein said method is conducted in the absence of a catalyst.

27. A method according to claim 1, wherein said method is conducted in the absence of water.

28. A method for preparing a polyurea, the method comprising:
providing a non-aromatic polyfunctional amine comprising a plurality of primary amino groups, each of the primary amino groups comprising an amino nitrogen atom and first and second reactive hydrogen atoms appended to the amino nitrogen atom;
reacting at least one of the primary amino groups of the non-aromatic polyfunctional amine with an effective molar amount of a non-aromatic reaction rate modifier to provide a secondary amino group, said reacting comprising replacing the first reactive hydrogen atom with a hydroxyl-containing moiety while leaving the second reactive hydrogen atom appended to the amino nitrogen atom; and
directing the non-aromatic polyfunctional amine having the secondary amino group and an aliphatic polyisocyanate comprising a plurality of isocyanate groups onto a substrate and into mutual contact with one another to effectuate mixing and reacting the isocyanate groups with at least one member selected from the group consisting of the primary and secondary amino groups to prepare the polyurea on the substrate.

29. A method according to claim 28, wherein the non-aromatic polyfunctional amine comprises a diamine.

30. A method according to claim 29, wherein the diamine comprises a member selected from the group consisting of a straight chain and branched diamine.

31. A method according to claim 29, wherein the diamine comprises a cycloaliphatic diamine.

32. A method according to claim 28, wherein the polyfunctional amine comprises a triamine.

33. (Canceled)

34. A method according to claim 28, wherein the effective molar amount of the non-aromatic reaction-rate modifier to the primary amino groups is in a range of about 1:3 to about 1:1.

35. A method according to claim 28, wherein the effective molar amount of the non-aromatic reaction-rate modifier to the primary amino groups is in a range of about 1:2 to about 2:3.

36. A method according to claim 28, wherein said reacting of the non-aromatic polyfunctional amine with the non-aromatic reaction modifier comprises a hydroxyalkylation reaction.

37. A method according to claim 28, wherein said reacting of the non-aromatic polyfunctional amine with the non-aromatic reaction rate modifier comprises replacing the first reactive hydrogen atom with a moiety comprising a secondary hydroxyl group.

38. A method according to claim 28, further comprising selecting an alkylene oxide as the reaction-rate modifier.

39. A method according to claim 38, wherein the alkylene oxide has 2 to 6 carbon atoms.

40. A method according to claim 38, wherein the alkylene oxide comprises a member selected from the group consisting of ethylene oxide and propylene oxide.

41. A method according to claim 28, further comprising selecting an alkylene carbonate as the reaction-rate modifier.

42. A method according to claim 41, wherein the alkylene carbonate comprises a member selected from the group consisting of ethylene carbonate and propylene carbonate.

43. A method according to claim 28, wherein the aliphatic polyisocyanate comprises a non-aromatic diisocyanate.

44. A method according to claim 43, wherein:
the non-aromatic diisocyanate comprises an alkylene moiety connecting the isocyanate groups; and
the alkylene moiety is selected from the group consisting of a straight-chain alkylene moiety, a branched alkylene moiety, and a straight-chain and branched alkylene moiety.

45. A method according to claim 44, wherein the alkylene moiety has 1 to 12 carbon atoms.

46. A method according to claim 43, wherein the non-aromatic diisocyanate comprises a cyclic alkylene moiety connecting the isocyanate groups, the cyclic alkylene moiety having 4 to 14 carbon atoms.

47. A method according to claim 28, wherein the aliphatic polyisocyanate comprises a non-aromatic triisocyanate.

48. A method according to claim 28, wherein said combining step is free of aromatic isocyanates.

49. A method according to claim 28, wherein the aliphatic polyisocyanate comprises an aromatic ring and a tertiary carbon, wherein the tertiary carbon is appended to one of the isocyanate groups.

50. A method according to claim 49, wherein the aliphatic polyisocyanate comprises tetramethylxylenediisocyanate.

51. A method according to claim 28, wherein the non-aromatic polyfunctional amine having the secondary amino group comprises a first non-aromatic polyfunctional amine, wherein said method further comprises blending the first non-aromatic polyfunctional amine with a second non-aromatic polyfunctional amine comprising a plurality of second primary amino groups.

52. A method according to claim 51, wherein the second non-aromatic polyfunctional amine comprises polyoxyalkyleneamine.

53. A method according to claim 28, wherein said method is conducted in the absence of a catalyst.

54. A method according to claim 28, wherein said method is conducted in the absence of water.

55. A method according to claim 28, wherein said directing comprises spraying the non-aromatic secondary polyfunctional amine and the aliphatic polyisocyanate onto the substrate.
